(19) United States
(12) Patent Application Publication
(10) Pub. No.: US 2017/0237655 A1
(43) Pub. Date: Aug. 17, 2017

(54) Forwarding Data Packets In Software Defined Networks

(71) Applicant: Hewlett Packard Enterprise Development LP, Houston, TX (US)

(72) Inventor: Bihui YANG, Beijing (CN)

(21) Appl. No.: 15/514,601

(22) PCT Filed: Sep. 28, 2015
(86) PCT No.: PCT/CN2015/090895

§ 371 Date: Mar. 27, 2017

(30) Foreign Application Priority Data
Sep. 28, 2014 (CN) 201410507966.4

(51) Int. Cl. H04L 12/721; H04L 12/24; H04L 12/713; H04L 12/751; H04L 12/46; H04L 12/741; H04L 29/12

(52) U.S. Cl. CPC H04L 45/38; H04L 45/745; H04L 45/66; H04L 41/0846; H04L 61/2038; H04L 61/2007; H04L 45/02; H04L 61/103; H04L 12/4633; H04L 45/586; H04L 61/6022

(57) ABSTRACT

A software defined network (SDN) controller may configure a Layer-three gateway for a network segment in a hybrid network device within a SDN network, receive a Packet-in message encapsulated with a Layer-three data packet from a SDN network device, calculate an optimum path from source media access control (MAC) address of the data packet to destination MAC address of the data packet, and issue a flow entry to each network device in the optimum path. Subsequently, each network device may forward the data packet based on the flow entry.

### BACKGROUND

Software defined network (SDN) is a structure of a new network. The SDN may separate control plane of a network device from forwarding plane of the network device, so as to flexibly control network flow. In a SDN network, a standard protocol at present is OpenFlow protocol.

The SDN network mainly consists of a SDN network device (such as a switch) and a SDN controller, which are connected with each other through a SDN protocol channel.

The SDN controller is a control center, which may generate flow tables and issue to SDN network devices, based on user configuration or dynamic running protocol. After receiving the flow tables set by the SDN controller, the SDN network device may process packets based on the flow tables. The SDN network device and the SDN controller may communicate with each other through the SDN protocol channel (such as OpenFlow channel).

### BRIEF DESCRIPTIONS OF THE DRAWINGS

FIG. 1 is a flowchart illustrating a forwarding method in a SDN network, in accordance with an example of the present disclosure.

FIG. 2 is a flowchart illustrating another forwarding method in the SDN network, in accordance with an example of the present disclosure.

FIG. 3 is a flowchart illustrating a method for configuring and learning a Layer-three gateway in the SDN network, in accordance with an example of the present disclosure.

FIG. 4 is a flowchart illustrating a forwarding method within the SDN network, in accordance with an example of the present disclosure.

FIG. 5 is a flowchart illustrating a Layer-three forwarding method between a SDN network and a non-SDN network, in accordance with an example of the present disclosure.

FIG. 6 is a schematic diagram illustrating a SDN network, in accordance with an application example of the present disclosure.

FIG. 7 is a flowchart illustrating a method for configuring and learning gateway in the network shown in FIG. 6, in accordance with an example of the present disclosure.

FIG. 8 is a flowchart illustrating a Layer-three forwarding method within the SDN network shown in FIG. 6, in accordance with an example of the present disclosure.

FIG. 9 is a flowchart illustrating a Layer-three forwarding method between a SDN network shown in FIG. 6 and a non-SDN network, in accordance to with an example of the present disclosure.

FIG. 10 is a schematic diagram illustrating structure of a Layer-three forwarding device in the SDN network, in accordance with an example of the present disclosure.

FIG. 11 is a schematic diagram illustrating hardware structure of a SDN controller, in accordance with an example of the present disclosure.

FIG. 12 is a schematic diagram illustrating structure of a Layer-three forwarding device in the SDN network, in accordance with an example of the present disclosure.

FIG. 13 is a schematic diagram illustrating hardware structure of a hybrid SDN network device, in accordance with an example of the present disclosure.

### DETAILED DESCRIPTIONS

To facilitate understanding of the present disclosure, the following descriptions are provided.

1) The SDN network refers to a network, which enables the SDN protocol (such as OpenFlow protocol), including a SDN controller, a SDN network device and a host connecting with the SDN network device in the SDN network.

2) The non-SDN network refers to a network, which does not enable the SDN protocol, and may include the following devices in the non-SDN network, such as switch, host.

3) The hybrid network device refers to a network device, which may support SDN protocol functions, as well as conventional network functions such as Layer-two forwarding and Layer-three forwarding in the non-SDN network.

4) In the hybrid network device, a port enabling the SDN protocol may belong to the SDN network. A port not enabling the SDN protocol may belong to the non-SDN network.

5) The Layer-three forwarding refers to forwarding data packets by searching in a route table based on internet protocol (IP) address.

FIG. 1 is a flowchart illustrating a forwarding method in the SDN network, in accordance with an example of the present disclosure. Specific blocks may be as follows.

In block 201, a SDN controller may configure a Layer-three gateway of a network segment in a hybrid network device within the SDN network. Further the SDN controller generates a virtual host for the gateway in the SDN controller. The IP address and media access control (MAC) address of the virtual host may be respectively an IP address and a MAC address of the gateway. The output port of the virtual host may be Normal port.

If the SDN network has one network segment, then the SDN controller may generate a Layer-three gateway corresponding to the network segment in the hybrid network device. If the SDN network has a plurality of network segments, then the SDN controller may generate a respective Layer-three gateway in the hybrid network device for each respective network segment. For instance, a single hybrid network device may host a plurality of layer-three gateways, each gateway corresponding to a respective SDN network segment. For example, 10.0.0.0/24 may be referred to a first network segment. An IP address of a Layer-three gateway corresponding to the first network segment may be 10.0.0.1. 20.0.0.0/24 may be referred to as a second network segment. An IP address of a Layer-three gateway corresponding to the second network segment may be 20.0.0.1.

Configure the Layer-three gateway for each network segment in the hybrid network device may include as follows. Configure a Layer-three interface with Layer-three forwarding functions corresponding to each network segment in the hybrid network device. Since the IP address and MAC address of the virtual host are respectively the IP address and MAC address of a corresponding gateway, the virtual host destined for the corresponding Layer-three gateway may be connected with, or be located in the hybrid network device in the SDN network topology. Subsequently, flow entry in the Layer-three gateway for packet forwarding may be calculated. The output port of the virtual host may be the Normal port, that is, the output port of the flow entry for packet forwarding in the Layer-three gateway generated by the SDN controller may be the Normal port. The virtual host may be a static virtual host, which means that the virtual host will never aging.

The Normal port is a kind of port defined by the SDN protocol. Characteristics of the Normal port may be as follows. When an output port of a packet is the Normal port, forwarding behavior of the packet may be changed to Layer-two/Layer-three forwarding. When an output port of a packet is the Normal port, the packet may be forwarded according to conventional layer 2 and layer 3 networking protocols, while when an output port of a packet is not the Normal port, the packet may be forwarded according to SDN networking protocol. In one example, the port number of the Normal port may be 0xfffffffa.

When receiving a Packet-in message encapsulated with an address resolution protocol (ARP) request packet from a SDN network device, in which the ARP request packet is transmitted by a host connected with the SDN network device, and destination IP address of the ARP request packet is gateway IP address, the SDN controller may search for a corresponding virtual host based on the gateway IP address, take the MAC address of the virtual host as gateway MAC address and fill into an ARP reply packet. And then, the SDN controller may encapsulate the ARP reply packet into a Packet-out message, and forward to the host transmitting the ARP request packet through the SDN network device. The SDN controller may also configure an ARP entry in a gateway corresponding to the gateway IP address. The IP address and MAC address of the ARP entry may be respectively the source IP address and source MAC address of the ARP request packet. The output port in the ARP entry may be the output port in the optimal path, which is from the gateway to the host transmitting the ARP request packet.

In block 202, the SDN controller may receive the Packet-in message encapsulated with a data packet from the SDN network device, calculate the optimum path from the source MAC address of the data packet to the destination MAC address of the data packet, based on learned SDN network topology and generated virtual host. The SDN controller may also issue flow entry to each network device in the optimum path, such that each network device may forward the data packet to a device corresponding to the destination MAC address, based to on the flow entry issued to the each network device.

When the source IP address and source MAC address in the data packet are respectively the IP address and MAC address of a first host in a first network segment, destination IP address of the data packet is IP address of a second host in the first or second network segment, destination MAC address of the data packet is the gateway MAC address of the first network segment, in block 202, calculate the optimum path from the source MAC address of the data packet to the destination MAC address of the data packet, based on the learned SDN network topology and generated virtual host may be as follows:

the optimum path from the ingress port of the data packet in the SDN network device to the Normal port of the virtual host, which may correspond to the gateway MAC address (that is, the destination MAC address of the data packet) of the first network segment.

In block 202, issue the flow entry to each network device in the optimum path may include as follows.

Generate the flow entry to be issued to the gateway of the first network segment, based on the data packet and the optimum path. Content of the flow entry may be as follows. A data packet which may meet the following conditions. The destination MAC address of the data packet may be the gateway MAC address of the first network segment. The action of the data packet may be Output. And the output port of the data packet may be the Normal port.

In block 202, issue the flow entry to each network device in the optimum path may further include as follows.

The SDN controller may encapsulate the data packet into a Packet-out message. The output port carried by the Packet-out message may be the output port of the SDN network device transmitting the Packet-in message in the optimum path. The optimum path may be from the SDN network device transmitting the Packet-in message to the gateway of the first network segment. The SDN controller may transmit the Packet-out message to the SDN network device, which transmits the Packet-in message. Subsequently, after receiving the Packet-out message, the SDN network device transmitting the Packet-in message may forward the data packet through the output port.

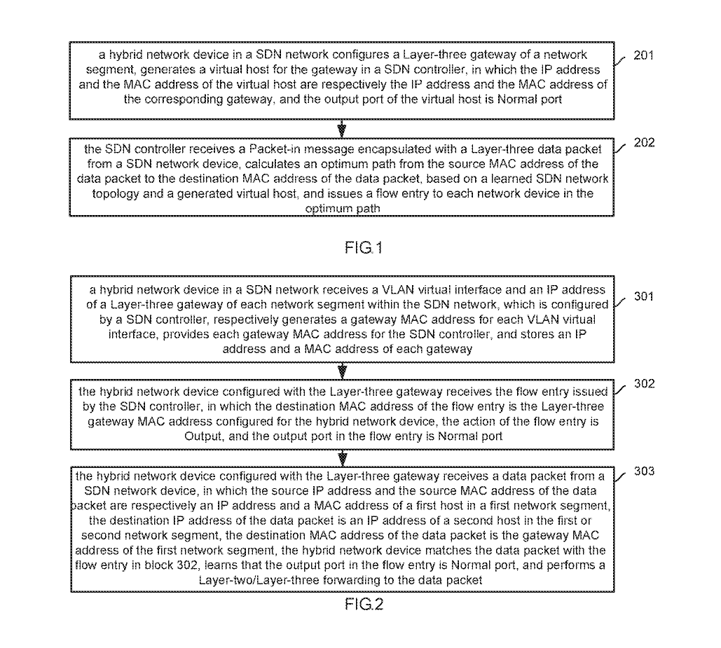

The following examples are provided supposing there are at least two network segments in the SDN network, but which may be similar when the SDN network has one network segment. FIG. 2 is a flowchart illustrating another forwarding method in the SDN network, in accordance with an example of the present disclosure. Specific blocks may be as follows.

In block 301, a hybrid network device in the SDN network may receive a virtual local area network (VLAN) virtual interface and an IP address of a Layer-three gateway of each network segment in the SDN network, which are configured by a SDN controller, respectively generate a gateway MAC address for each VLAN virtual interface, provide each gateway MAC address for the SDN controller, and store IP address and MAC address of each gateway.

In block 302, the hybrid network device configured with the Layer-three gateway may receive a flow entry issued by the SDN controller. Destination MAC address in the flow entry may be the Layer-three gateway MAC address configured for the hybrid network device. The action in the flow entry may be Output. The output port in the flow entry may be the Normal port.

In block 303, the hybrid network device configured with the Layer-three gateway may receive a data packet from a SDN network device. Source IP address and source MAC address of the data packet may be respectively IP address and MAC address of a first host in a first network segment. Destination IP address of the data packet may be IP address of a second host in the first or second network segment. Destination MAC address of the data packet may be the gateway MAC address of the first network segment. When the data packet matches with the flow entry in block 302, the hybrid network device may learn that the output port of the flow entry is the Normal port, and perform Layer-two/Layer-three forwarding process to the data packet.

In block 303, perform the Layer-three forwarding process to the data packet may include as follows.

The hybrid network device may search for the corresponding MAC address and the output port in the ARP entry therein, based on the destination IP address of the data packet, so as to replace the destination MAC address of the data packet with the MAC address searched out. In an example, the destination IP address of the data packet may be IP address of the second host in the second network segment. And then, the hybrid network device may search out to gateway MAC address of the second network segment, based on the second network segment located by the destination IP address of the data packet, replace the source MAC address of the data packet with the gateway MAC address, and forward the data packet through the output port searched out.

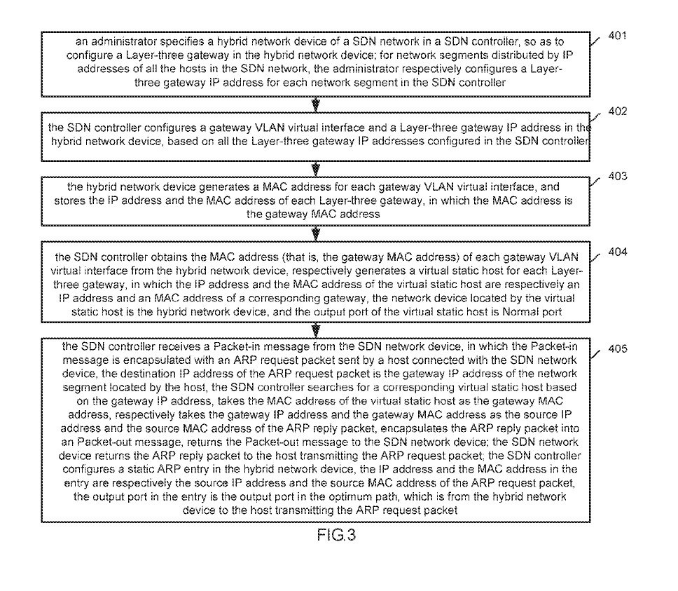

FIG. 3 is a flowchart illustrating a method for configuring and learning a Layer-three gateway in the SDN network, in accordance with an example of the present disclosure.

In block 401, administrator may specify a hybrid network device within the SDN network in a SDN controller, so as to configure a Layer-three gateway in the hybrid network device. The administrator may respectively configure a Layer-three gateway IP address for each network segment in the SDN controller, for all the network segments distributed by IP address of each host within the SDN network.

In block 402, the SDN controller may configure a gateway VLAN virtual interface and Layer-three gateway IP address in the hybrid network device, based on all the Layer-three gateway IP addresses configured in the SDN controller.

Number of gateway VLAN virtual interfaces may be same as that of VLANs, which are distributed by all the Layer-three gateway IP addresses.

The SDN controller may configure the gateway VLAN virtual interface and Layer-three gateway IP address in the hybrid network device, by using Netconf protocol or command line.

In block 403, the hybrid network device may generate a MAC address for each gateway VLAN virtual interface, store IP address and MAC address of each Layer-three gateway. The foregoing MAC address may be the gateway MAC address.

In block 404, the SDN controller may obtain the MAC address (that is, the gateway MAC address) of each gateway VLAN virtual interface from the hybrid network device, and respectively generate a virtual static host for each Layer-three gateway. The IP address and MAC address of the virtual static host may be respectively the IP address and MAC address of a corresponding gateway. The network device located by the virtual static host may be the hybrid network device. And the output port of the virtual static host may be the Normal port.

The SDN controller may obtain the MAC address of each gateway VLAN virtual interface from the hybrid network device, by using Netconf protocol or command line.

In block 405, the SDN controller may receive a Packet-in message, which is encapsulated with an ARP request packet, from a SDN network device. The ARP request packet may be transmitted by a host connected with the SDN network device. Destination IP address of the ARP request packet may be gateway IP address of a network segment located by the host. The SDN controller may search out a corresponding virtual static host based on the gateway IP address, take the MAC address of the virtual static host as the gateway MAC address, respectively take gateway IP address and gateway MAC address as source IP address and source MAC address of an ARP reply packet, encapsulate the ARP reply packet into a Packet-out message, and return the Packet-out message to the SDN network device. And then, the SDN network device may return the ARP reply packet to the host, which transmits the ARP request packet. The SDN controller may also configure a static ARP entry in the hybrid network device. The IP address and MAC address in the static ARP entry may be respectively the source IP address and source MAC address of the ARP request packet. The output port in the static ARP entry may be the output port of the hybrid network device in the optimum path. And the optimum path may be from the hybrid network device to the host transmitting the ARP request packet.

The SDN controller may configure the static ARP entry in the hybrid network device, by using Netconf protocol or command line.

When a host is to transmit inter-network segment flow without learning a corresponding gateway MAC address, the host may transmit an ARP request packet, destination IP address thereof may be the gateway IP address, so as to search for the gateway MAC address. When receiving the ARP reply packet, the host may store the source IP address and source MAC address of the ARP reply packet, that is, the gateway IP address and gateway MAC address.

The gateway IP address may be pre-configured in the host. When the gateway supports replying to the ARP request in the SDN network, after receiving the Packet-in message encapsulated with the ARP request packet, the SDN controller may broadcast the ARP request packet, without performing ARP response process. When the ARP request packet arrives at a gateway (that is, the hybrid network device configured with the gateway), which may correspond to the destination IP address of the ARP request packet, the gateway may execute the ARP response process, and generate a static ARP entry therein.

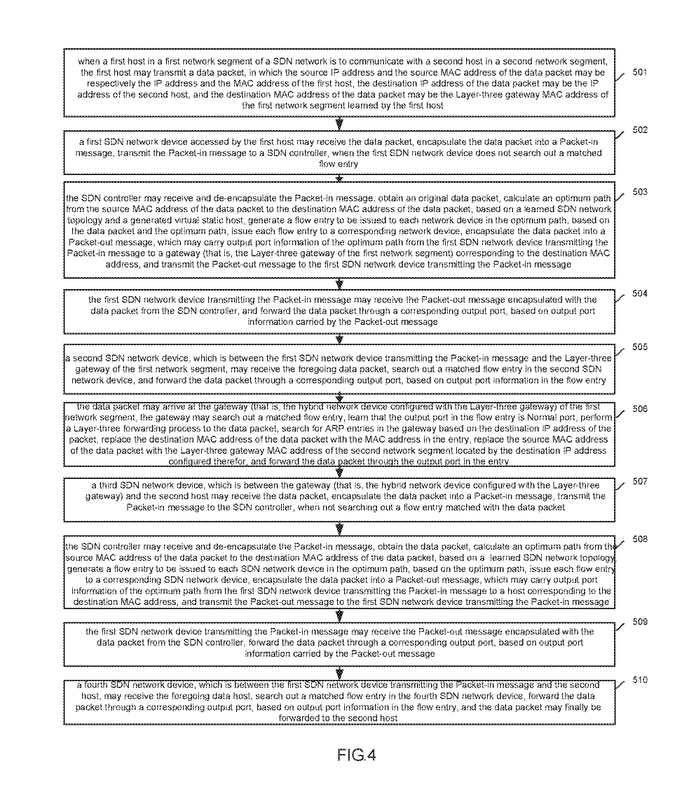

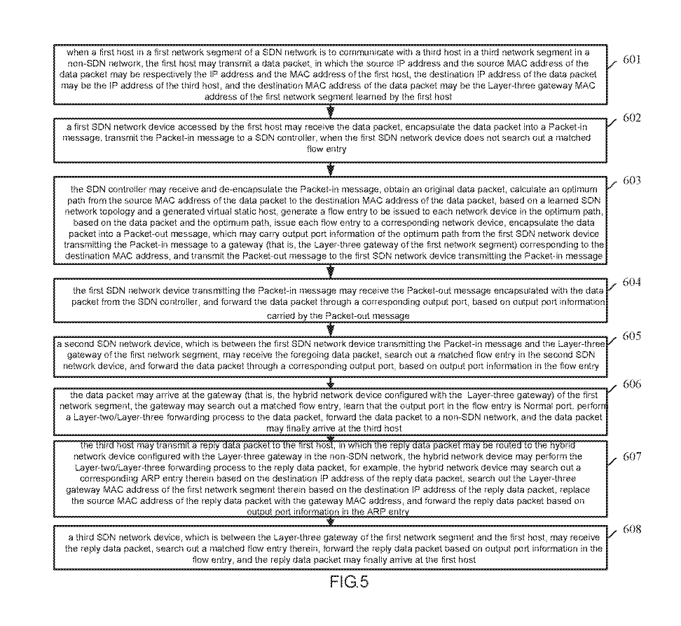

FIG. 4 is a flowchart illustrating a Layer-three forwarding method in the SDN network, in accordance with an example of the present disclosure. Specific blocks may be as follows.

In block 501, a first host in a first network segment within the SDN network is to communicate with a second host in a second network segment, the first host may transmit a data packet. Source IP address and source MAC address of the data packet may be respectively IP address and MAC address of the first host. Destination IP address of the data packet may be the IP address of the second host. Destination MAC address of the data packet may be the Layer-three gateway MAC address of the first network segment, which has been learned by the first host.

The first host may learn the Layer-three gateway MAC address of the first network segment located by the first host as in block 405.

In block 502, SDN network device accessed by the first host may receive the data packet. When no matched flow entry in the SDN network device is searched out, the SDN network device may encapsulate the data packet into a Packet-in message, and transmit the Packet-in message to a SDN controller.

In block 503, the SDN controller may receive and de-encapsulate the Packet-in message, and obtain original data packet. The SDN controller may calculate the optimum path, which is from source MAC address of the data packet to destination MAC address of the data packet, based on learned SDN network topology and generated virtual static host. The SDN controller may generate a flow entry to be issued to each network device in the optimum path, based on the data packet and the optimum path, and then issue each flow entry to a corresponding network device. The SDN controller may also encapsulate the data packet into a Packet-out message. The Packet-out message may carry output port information of the optimum path, which is from the SDN network device transmitting the Packet-in message to the gateway (that is, the to Layer-three gateway of the first network segment) corresponding to the destination MAC address. And then, the SDN controller may transmit the Packet-out message to the SDN network device transmitting the Packet-in message.

Content of the flow entry issued to each SDN network device (which may be between the first host and the Layer-three gateway of the first network segment) in the optimum path may be as follows.

A data packet which may meet the following conditions. The source MAC address of the data packet may be the MAC address (that is, the source MAC address of the data packet) of the first host. The destination MAC address of the data packet may be the Layer-three gateway MAC address (that is, the destination MAC address of the data packet) of the first network segment. The action of the data packet may be Output. The output port of the data packet may be the output port of the SDN network device in the optimum path. And the optimum path may be from the SDN network device to the gateway (corresponding to the destination MAC address).

Content of the flow entry issued to the gateway (corresponding to the destination MAC address) may be as follows.

A data packet which may meet the following conditions. The source MAC address of the data packet may be the MAC address (that is, the source MAC address of the data packet) of the first host. The destination MAC address of the data packet may be the Layer-three gateway MAC address (that is, the destination MAC address of the data packet) of the first network segment. The action of the data packet may be Output. The output port of the data packet may be the Normal port of the virtual static host, which has been searched out based on the destination MAC address of the data packet.

The flow entry to be issued to the gateway may not include the source MAC address, so as to save flow table.

After starting, the SDN controller may learn the SDN network topology, which may include: connection relationship between a network device within the SDN network and hosts connected therewith, connection relationship between each network device (including connection relationship between SDN network devices, between hybrid network devices, between SDN network device and to hybrid network device).

In block 504, a first SDN network device, which transmits the Packet-in message, may receive the Packet-out message encapsulated with the data packet from the SDN controller, and forward the data packet through a corresponding output port, based on output port information carried by the Packet-out message.

In block 505, a second SDN network device, which is between the first SDN network device transmitting the Packet-in message and the Layer-three gateway of the first network segment, may receive the foregoing data packet, search out a matched flow entry, and forward the data packet through a corresponding output port, based on the output port information in the flow entry.

In block 506, when the data packet arrives at a gateway (that is, a hybrid network device configured with the Layer-three gateway) of the first network segment, the gateway may search out a matched flow entry, learn that the output port in the flow entry may be the Normal port, and then perform a Layer-three forwarding process to the data packet. That is, the gateway may search in ARP entries of the gateway, based on destination IP address of the data packet, replace destination MAC address of the data packet with MAC address in the ARP entry, replace source MAC address of the data packet with Layer-three gateway MAC address of the second network segment, which may be located by the destination IP address configured by the gateway, and forward the data packet based on the output port in the ARP entry.

When the hybrid network device does not store ARP entry corresponding to destination IP address of the data packet, the hybrid network device may transmit an ARP request packet. Destination IP address of the ARP request packet may be foregoing destination IP address of the data packet. Thus, the hybrid network device may learn a corresponding ARP entry. In an example, in block 503, before learning ARP entry corresponding to destination IP address of the data packet, the SDN controller may transmit an ARP request packet. Destination IP address of the ARP request packet may be foregoing destination IP address of the data packet. And then, the SDN controller may learn the corresponding ARP entry, and issue the ARP entry to the hybrid network device.

In block 507, a third SDN network device between the gateway (that to is, the hybrid network device configured with the Layer-three gateway) and the second host may receive the data packet, encapsulate the data packet into the Packet-in message, and transmit the Packet-in message to the SDN controller, when not searching out a flow entry corresponding to the data packet.

In block 508, the SDN controller may receive and de-encapsulate the Packet-in message, obtain the data packet, calculate the optimum path from the source MAC address of the data packet to the destination MAC address of the data packet, based on learned SDN network topology, generate a flow entry to be issued to each SDN network device in the optimum path based on the optimum path, and issue each flow entry to a corresponding SDN network device. The SDN controller may also encapsulate the data packet into the Packet-out message, and transmit the Packet-out message to the first SDN network device transmitting the Packet-in message. The Packet-out message may carry output port information of the first SDN network device transmitting the Packet-in message in the optimum path. And the optimum path may be from the first SDN network device to the host corresponding to the destination MAC address.

Content of the flow entry to be issued to the gateway (corresponding to the source MAC address, that is, the hybrid network device configured with the gateway) may be as follows.

A data packet which may meet the following conditions. The source MAC address of the data packet may be Layer-three gateway MAC address (that is, source MAC address of the data packet) of the second network segment. The destination MAC address of the data packet may be MAC address (that is, destination MAC address of the data packet) of the second host. The action of the data packet may be Output. The output port of the data packet may be the output port of the gateway in the optimum path. And the optimum path may be from the gateway to the second host.

In another method of the present disclosure, the foregoing flow entry may be not issued to the gateway (corresponding to the source MAC address, that is, the hybrid network device configured with the gateway).

Content of the flow entry to be issued to each network device in the optimum path (that is, each SDN network device between Layer-three gateway of the second network segment and the second host) may be as follows.

A data packet which may meet the following conditions. The source MAC address of the data packet may be the Layer-three gateway MAC address (that is, source MAC address of the data packet) of the second network segment. The destination MAC address of the data packet may be MAC address (that is, destination MAC address of the data packet) of the second host. The action of the data packet may be Output. The output port of the data packet may be output port of the SDN network in the optimum path. And the optimum path may be from the SDN network device (corresponding to destination MAC address) to the second host.

In block 509, the first SDN network device, which transmits the Packet-in message, may receive the Packet-out message encapsulated with the data packet from the SDN controller, and forward the data packet through a corresponding output port, based on output port information carried by the Packet-out message.

In block 510, a second SDN network device, which is between the first SDN network device transmitting the Packet-in message and the second host, may receive the foregoing data packet, search out a matched flow entry in the second SDN network device, and forward the data packet through a corresponding output port, based on output port information in the flow entry. And then, the data packet may finally be forwarded to the second host.

FIG. 5 is a flowchart illustrating a Layer-three forwarding method between a SDN network and a non-SDN network, in accordance with an example of the present disclosure. Specific blocks may be as follows.

In block 601, a first host in a first network segment within a SDN network may communicate with a third host in a third network segment of a non-SDN network. The first host may transmit a data packet. Source IP address and source MAC address of the data packet may be respectively IP address and MAC address of the first host. Destination IP address of the data packet may be IP address of the third host. Destination MAC address of the data packet may be Layer-three gateway MAC address of the first network segment, which is learned by the first host.

In block 602, a first SDN network device accessed by the first host may receive the data packet, encapsulate the data packet into a Packet-in to message, and transmit the Packet-in message to a SDN controller, when not searching out a matched flow entry in the first SDN network device.

In block 603, the SDN controller may receive and de-encapsulate the Packet-in message, obtain original data packet, calculate the optimum path from source MAC address of the data packet to destination MAC address of the data packet, based on learned SDN network topology and generated virtual static host. The SDN controller may generate a flow entry to be issued to each network device in the optimum path, based on the data packet and the optimum path, and issue each flow entry to a corresponding network device. The SDN controller may also encapsulate the data packet into a Packet-out message, and transmit the Packet-out message to the first SDN network device transmitting the Packet-in message. The Packet-out message may carry output port information of the optimum path, which is from the first SDN network device transmitting the Packet-in message to the gateway (that is, Layer-three gateway of the first network segment) corresponding to the destination MAC address.

Content of the flow entry issued to each SDN network device (between the first host and the Layer-three gateway of the first network segment) in the optimum path may be as follows.

A data packet which may meet the following conditions. The source MAC address of the data packet may be MAC address (that is, source MAC address of the data packet) of the first host. The destination MAC address of the data packet may be Layer-three gateway MAC address (that is, destination MAC address of the data packet) of the first network segment. The action of the data packet may be Output. The output port of the data packet may be the output port of the first SDN network device in the optimum path. And the first SDN network device may be from the first SDN network device to the gateway (corresponding to the destination MAC address).

Content of the flow entry issued to the gateway (corresponding to the destination MAC address) may be as follows.

A data packet which may meet the following conditions. The source MAC address of the data packet may be MAC address (that is, source MAC address of the data packet) of the first host. The destination MAC address of the data packet may be Layer-three gateway MAC address (that is, destination MAC address of the data packet) of the first network segment. The action of the data packet may be Output. The output port of the data packet may be Normal port of the virtual static host, which has been searched out based on destination MAC address of the data packet.

The flow entry issued to the gateway may not include the source MAC address, so as to save flow table.

In block 604, after receiving the Packet-out message encapsulated with the data packet from the SDN controller, the first SDN network device transmitting the Packet-in message may forward the data packet through a corresponding output port, based on output port information carried by the Packet-out message.

In block 605, after receiving the foregoing data packet, a second SDN network device, which is between the first SDN network device transmitting the Packet-in message and the Layer-three gateway of the first network segment, may search out a matched flow entry in the second SDN network device, and forward the data packet through a corresponding output port, based on output port information in the flow entry.

In block 606, after the data packet arrives at the gateway (that is, hybrid network device configured with Layer-three gateway) of the first network segment, the gateway may search out a matched flow entry, and learn that the output port in the flow entry is Normal port. And then, the gateway may perform a Layer-three forwarding process to the data packet, forward the data packet to the non-SDN network. The data packet may finally arrive at the third host.

In block 607, the third host may transmit a reply data packet to the first host. The reply data packet may be routed to the hybrid network device configured with Layer-three gateway in the non-SDN network. The hybrid network device may perform a Layer-three forwarding process to the reply data packet, e.g., search for a corresponding ARP entry in the hybrid network device based on destination IP address of the reply data packet, search for Layer-three gateway MAC address of the corresponding first network segment in the hybrid network device, based on destination IP address of the reply data packet, replace source MAC address of the reply data packet with the Layer-three gateway MAC address of the first network segment, and forward the reply data packet based on to output port information in the ARP entry.

In block 608, a third SDN network device, which is between Layer-three gateway of the first network segment and the first host, may receive the reply data packet, search out a matched flow entry in the third SDN network device, and forward the reply data packet based on output port information in the flow entry, such that the reply data packet may finally arrive at the first host.

When the third SDN network device, which is between Layer-three gateway of the first network segment and the first host, does not search out a matched flow entry, the third SDN network device may encapsulate the reply data packet into Packet-in message, and transmit the Packet-in message to the SDN controller. And then, the SDN controller may execute processes similar to that in block 508.

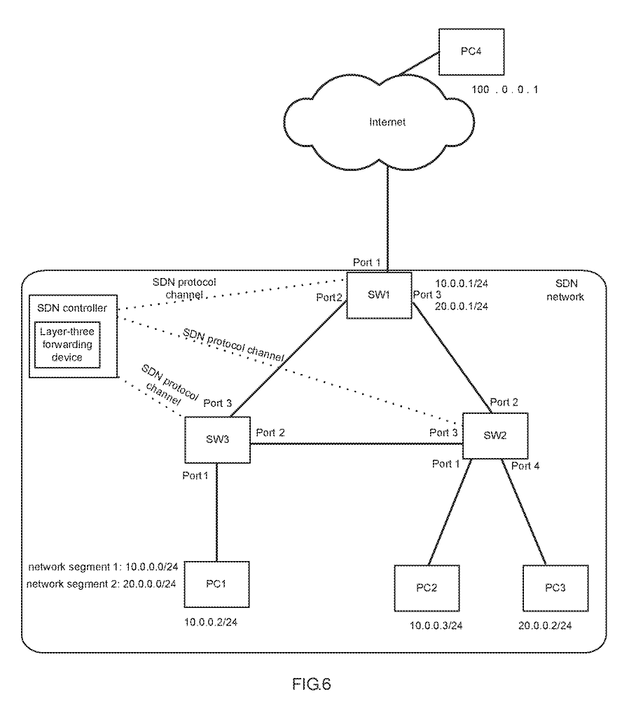

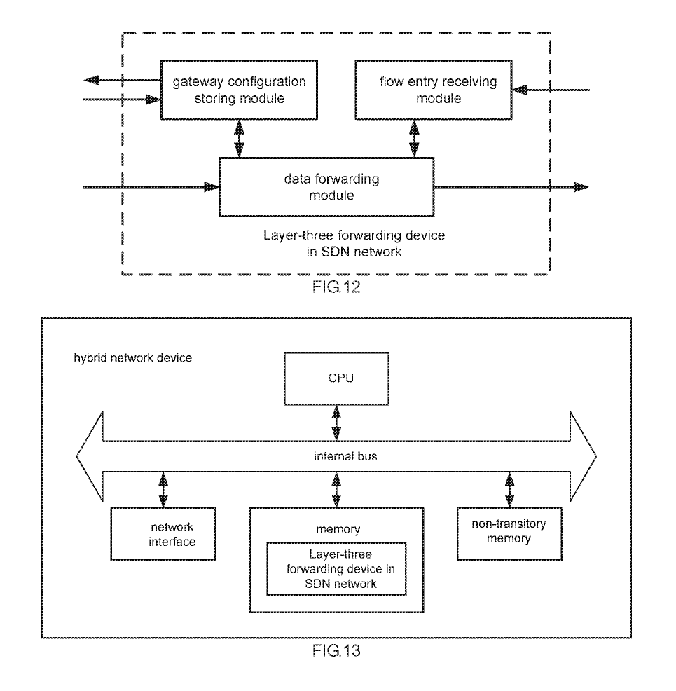

FIG. 6 is a schematic diagram illustrating a SDN network, in accordance with an application example of the present disclosure. In FIG. 6, the SDN network may include a SDN controller with a Layer-three forwarding device, switches SW1, SW2 and SW3. SW1, SW2 and SW3 are all connected with the SDN controller through a SDN protocol channel. SW1 may be a hybrid switch. SW3 may be connected with host PC1. IP address of PC1 may be 10.0.0.2. SW2 may be connected with hosts PC2 and PC3. IP address of PC2 and PC3 may be respectively 10.0.0.3 and 20.0.0.2. Thus, it can be seen that, PC1 and PC2 may be located in a same network segment 1, that is 10.0.0.0/24. PC3 may be located in a network segment 2, that is, 20.0.0.0/24. Subsequently, PC1 and PC3 may be located in different network segments. PC2 and PC3 may also be located in different network segments. Besides, an IP address of a Layer-three gateway corresponding to network segment 1 may be 10.0.0.1. An IP address of a Layer-three gateway corresponding to network segment 2 may be 20.0.0.1. The hybrid switch SW1 possesses two IP addresses, that is, 10.0.0.1 and 20.0.0.1. Host PC4 may be located in a non-SDN network. IP address of PC4 may be 100.0.0.1. Structures of the SDN controller and the Layer-three forwarding device may respectively refer to FIG. 11 and FIG. 12, which will not be repeated here.

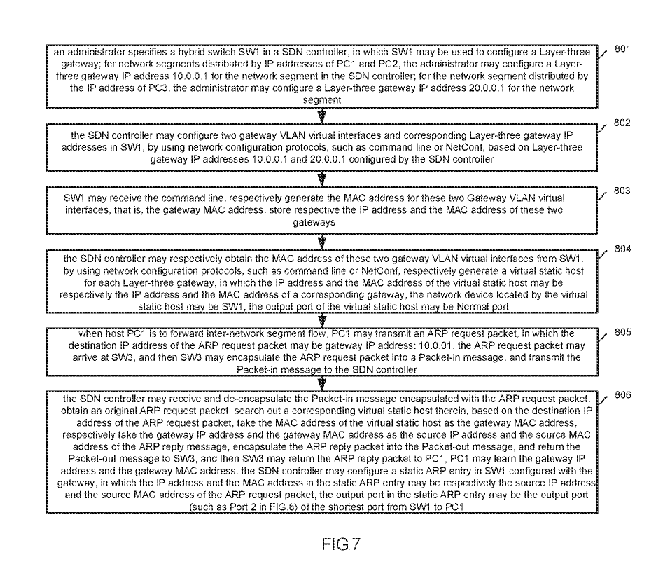

FIG. 7 is a flowchart illustrating a method to configure and learn a gateway in the network shown in FIG. 6, in accordance with an example of the to present disclosure. Specific blocks may be as follows.

In block 801, administrator may specify hybrid switch SW1 (a kind of hybrid network device), which may be used to configure a Layer-three gateway, by using a SDN controller. For network segment distributed by IP addresses of PC1 and PC2, the administrator may configure a Layer-three gateway IP address 10.0.0.1 for the network segment in the SDN controller. For network segment distributed by IP address of PC3, the administrator may configure a Layer-three gateway IP address 20.0.0.1 for the network segment by using the SDN controller.

In block 802, the SDN controller may configure two gateway VLAN virtual interfaces and corresponding Layer-three gateway IP addresses in SW1, by using network configuration protocols, such as command line or Netconf, based on Layer-three gateway IP addresses 10.0.0.1 and 20.0.0.1 configured in the SDN controller.

In block 803, SW1 may receive the command line, respectively generate MAC address for these two gateway VLAN virtual interfaces, that is, gateway MAC address, and store respective IP address and MAC address of these two gateways.

In block 804, the SDN controller may obtain MAC addresses of these two gateway VLAN virtual interfaces from SW1, by using network configuration protocols, such as command line or Netconf. For each Layer-three gateway, the SDN controller may generate a virtual static host. IP address and MAC address of a virtual static host may be respectively IP address and MAC address of a corresponding gateway. Network device located by the virtual static host may be SW1. The output port of the virtual static host may be Normal port.

In block 805, when PC1 is to transmit inter-network segment flow before learning gateway MAC address, PC1 may transmit an ARP request packet. Destination IP address of the ARP request packet may be gateway IP address 10.0.0.1. After the ARP request packet arrives at SW3, SW3 may encapsulate the ARP request packet into Packet-in message, and transmit the Packet-in message to the SDN controller.

In block 806, after receiving the Packet-in message encapsulated with the ARP request packet, the SDN controller may de-encapsulate the Packet-in to message, obtain original ARP request packet, search out a corresponding virtual static host in the SDN controller, based on destination IP address of the ARP request packet, take MAC address of the virtual static host as gateway MAC address, respectively take gateway IP address and gateway MAC address as source IP address and source MAC address of an ARP reply packet, encapsulate the ARP reply packet into Packet-out message, and return the Packet-out message to SW3. SW3 may return the ARP reply packet to PC1. And then, PC1 may learn the gateway IP address and gateway MAC address. SDN controller may also configure a static ARP entry in SW1 configured with a gateway. IP address and MAC address in the static ARP entry may be respectively source IP address and source MAC address of the ARP request packet. The output port in the static ARP entry may be the output port (such as Port 2 in FIG. 6) in the shortest path (that is, the foregoing optimum path), which is from SW1 to PC1.

When PC2 or PC3 is to forward inter-network segment flow, PC2 or PC3 may also execute processes similar to that executed by PC1.

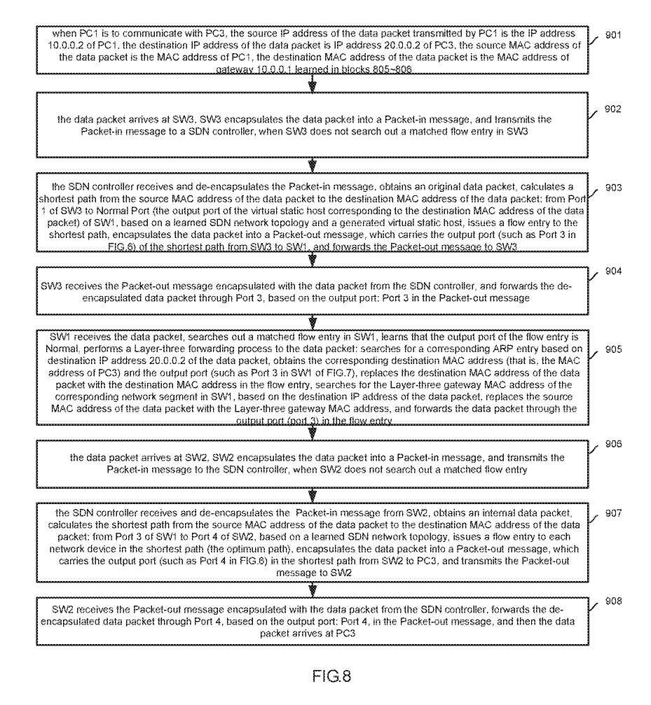

FIG. 8 is a flowchart illustrating a Layer-three forwarding method within the SDN network shown in FIG. 6, in accordance with an example of the present disclosure. Specific blocks may be as follows.

In block 901, when PC1 is to communicate with PC3. PC1 may transmit a data packet. Source IP address of the data packet may be IP address of PC1: 10.0.0.2. Destination IP address of the data packet may be IP address of PC3: 20.0.0.2. Source MAC address of the data packet may be MAC address of PC1. Destination MAC address of the data packet may be MAC address of gateway 10.0.0.1 learned in blocks 805-806.

In block 902, the data packet may arrive at SW3. SW3 may encapsulate the data packet into Packet-in message, and transmit the Packet-in message to a SDN controller, when SW3 does not search out a matched flow entry in SW3.

In block 903, the SDN controller may receive and de-encapsulate the Packet-in message, obtain original data packet, calculate the shortest path from source MAC address of the data packet to destination MAC address of the data packet, based on learned SDN network topology and generated virtual static host. The foregoing shortest path may be from Port 1 of SW3 to Normal port (the to output port of virtual static host corresponding to destination MAC address of the data packet) of SW1. The SDN controller may issue a flow entry to the shortest path, encapsulate the data packet into Packet-out message, and forward the Packet-out message to SW3. The Packet-out message may carry the output port (such as Port 3 in FIG. 6) in the shortest path from SW3 to SW1.

Content of the flow entry issued to SW3 may be as follows.

A data packet which may meet the following conditions. The source MAC address of the data packet may be MAC address (that is, source MAC address of the data packet) of PC1. The destination MAC address of the data packet may be gateway MAC address (that is, destination MAC address of the data packet) of PC1. The action of the data packet may be Output. The output port of the data packet may be Port3.

Content of the flow entry issued to SW1 may be as follows.

A data packet which may meet the following conditions. The source MAC address of the data packet may be MAC address (that is, source MAC address of the data packet) of PC1. The destination MAC address of the data packet may be gateway MAC address (that is, destination MAC address of the data packet) of PC1. The action of the data packet may be Output. The output port of the data packet may be Normal port.

The flow entry issued to SW1 may be simplified as follows.

A data packet which may meet the following conditions. The destination MAC address of the data packet may be the gateway MAC address (that is, destination MAC address of the data packet) of PC1. The action of the data packet may be Output. The output port of the data packet may be Normal port

In block 904, SW3 may receive the Packet-out message encapsulated with the data packet from the SDN controller, and forward de-encapsulated data packet through Port 3, based on the output port: Port3 in the Packet-out message.

In block 905, SW1 may receive the data packet, and search out a matched flow entry in SW1. When the output port in the flow entry is Normal port, SW1 may perform Layer-three forwarding process to the data packet. Based on destination IP address: 20.0.0.2 of the data packet, SW1 may search for a corresponding ARP entry, obtain the corresponding destination MAC address (that is, MAC address of PC3) and the output port (such as Port 3 of SW1 in FIG. 6), replace destination MAC address of the data packet with destination MAC address in the ARP entry, search for Layer-three gateway MAC address of a corresponding network segment in SW1, based on destination IP address of the data packet, replace source MAC address of the data packet with foregoing Layer-three gateway MAC address of the corresponding network segment, and forward the data packet through the output port (port 3) in the ARP entry.

In block 906, the data packet may arrive at SW2. SW2 may search out a matched flow entry, and forward the data packet based on the flow entry. When SW2 does not search out a matched flow entry, SW2 may encapsulate the data packet into Packet-in message, and transmit the Packet-in message to the SDN controller.

In block 907, the SDN controller may receive the Packet-in message from SW2, de-encapsulate the Packet-in message, obtain internal data packet, calculate the shortest path from source MAC address of the data packet to destination MAC address of the data packet, based on learned SDN network topology. The foregoing shortest path may be from Port 3 of SW1 to Port 4 of SW2. The SDN controller may issue a flow entry to each network device in the shortest path. The SDN controller may also encapsulate the data packet into Packet-out message, which may carry the output port (such as Port 4 in FIG. 6) in the shortest path from SW2 to PC3, and transmit the Packet-out message to SW2.

Content of the flow entry issued to SW1 may be as follows.

A data packet which may meet the following conditions. The source MAC address of the data packet may be gateway MAC address (that is, source MAC address of the data packet) of PC3. The destination MAC address of the data packet may be MAC address (that is, destination MAC address of the data packet) of PC3. The action of the data packet may be Output. The output port of the data packet may be Port 3.

Content of the flow entry issued to SW2 may be as follows.

A data packet which may meet the following conditions. The source MAC address of the data packet may be the gateway MAC address (that is, the to source MAC address of the data packet) of PC3. The destination MAC address of the data packet may be the MAC address (that is, the destination MAC address of the data packet) of PC3. The action of the data packet may be Output. The output port of the data packet may be Port 4.

To be compatible with the SDN protocol, flow entry may be issued to SW1. In the block, the flow entry may be not issued to SW1.

In block 908, SW2 may receive the Packet-out message encapsulated with the data packet from the SDN controller, and forward de-encapsulated data packet through Port 4, based on the output port, e.g., Port 4, in the Packet-out message. And then, the data packet may arrive at PC3.

FIG. 9 is a flowchart illustrating a Layer-three forwarding method between a SDN network shown in FIG. 6 and a non-SDN network, in accordance with an example of the present disclosure. Specific blocks may be as follows.

In block 1001, when PC1 is to communicate with PC4, PC1 may transmit a data packet. Source IP address of the data packet may be IP address of PC1, that is, 10.0.0.2. Destination IP address of the data packet may be IP address of PC4, that is, 100.0.0.1. Source MAC address of the data packet may be MAC address of PC1. Destination MAC address of the data packet may be MAC address of the gateway 10.0.0.1 learned in blocks 805-806.

In block 1002, the data packet may arrive at SW3. When SW3 does not search out a matched flow entry in SW3, SW3 may encapsulate the data packet into Packet-in message, and transmit the Packet-in message to a SDN controller.

In block 1003, the SDN controller may receive and de-encapsulate the Packet-in message, obtain original data packet, calculate the shortest path from source MAC address of the data packet to destination MAC address of the data packet, based on learned SDN network topology and generated virtual static host. The foregoing shortest path may be from Port1 of SW3 to Normal port (the output port of virtual static host corresponding to destination MAC address of the data packet) of SW1. The SDN controller may also issue a flow entry to each network device in the shortest path, encapsulate the data packet into Packet-out message, which may carry the output port (such as Port 3 in FIG. 6) in the shortest path from SW3 to SW1, and transmit the Packet-out message to SW3.

Content of the flow entry issued to SW3 may be as follows.

A data packet which may meet the following conditions. The source MAC address of the data packet may be MAC address (that is, source MAC address of the data packet) of PC1. The destination MAC address of the data packet may be gateway MAC address (that is, destination MAC address of the data packet) of PC1. The action of the data packet may be Output. The output port of the data packet may be Port3.

Content of the flow entry issued to SW1 may be as follows.

A data packet which may meet the following conditions. The source MAC address of the data packet may be MAC address (that is, source MAC address of the data packet) of PC1. The destination MAC address of the data packet may be gateway MAC address (that is, destination MAC address of the data packet) of PC1. The action of the data packet may be Output. The output port of the data packet may be Normal port.

The flow entry issued to SW1 may be simplified as follows.

A data packet which may meet the following conditions. The destination MAC address of the data packet may be gateway MAC address (that is, destination MAC address of the data packet) of PC1. The action of the data packet may be Output. The output port of the data packet may be Normal port.

In block 1004, SW3 may receive the Packet-out message encapsulated with the data packet from the SDN controller, and forward de-encapsulated data packet through Port 3, based on the output port, e.g., Port 3, in the Packet-out message.

In block 1005, SW1 may receive the data packet, search out a matched flow entry in SW1. When the output port in the flow entry is Normal port, SW1 may perform Layer-three forwarding process to the data packet, and forward the data packet through a port (such as Port 1 of SW1 in FIG. 6) destined for PC4. Subsequently, the data packet may finally arrive at PC4 through the non-SDN network.

In block 1006, PC4 may transmit a reply data packet to PC1. The reply data packet may be forwarded to SW1 through the non-SDN network. SW1 may perform Layer-three forwarding process to the reply data packet. That is, SW1 may search out a corresponding ARP entry in SW1, based on destination IP address of the reply data packet. SW1 may search out Layer-three gateway MAC address of the corresponding first network segment in SW1, based on destination IP address of the reply data packet. SW1 may replace source MAC address of the reply data packet with the Layer-three gateway MAC address of the first network segment, and forward the reply data packet through the output port (such as Port 2 in FIG. 6) in the ARP entry.

In block 1007, the reply data packet may arrive at SW3. SW3 may search out a matched flow entry in SW3, and forward the reply data packet through the output port (such as Port 1 in FIG. 6) in the flow entry. And then, the reply data packet may finally arrive at PC1.

When not searching out a matched flow entry, SW3 may encapsulate the reply data packet into Packet-in message, and transmit the Packet-in message to the SDN controller. And then, the SDN controller may execute processes similar to that in block 907.

It should be noted that, source IP address and destination IP address of the data packet may also be matched with the flow entry issued by the SDN controller in the examples of the present disclosure.

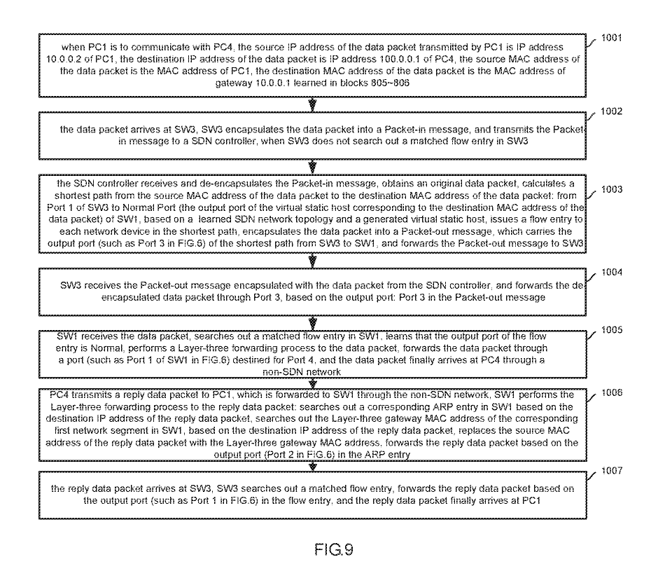

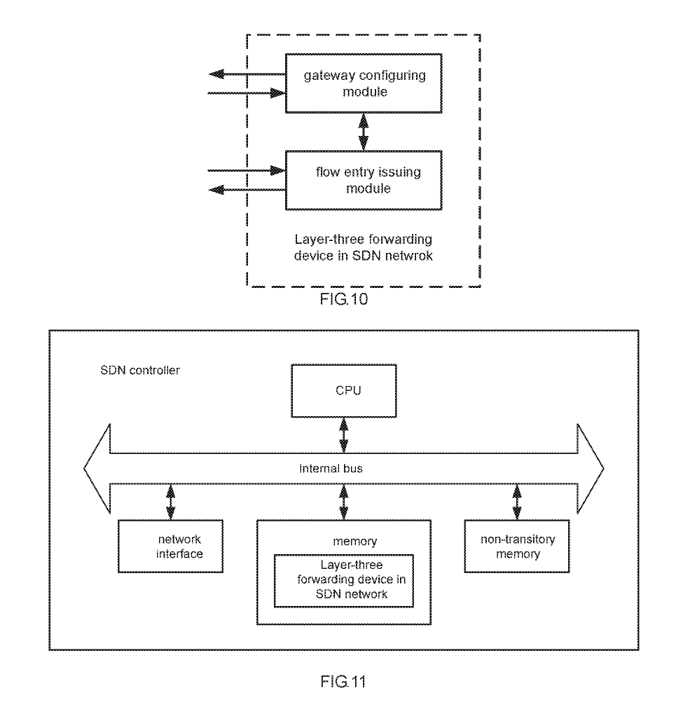

FIG. 10 is a schematic diagram illustrating structure of a Layer-three forwarding device in the SDN network, in accordance with an example of the present disclosure. As shown in FIG. 10, the Layer-three forwarding device in the SDN network may include a gateway configuring module and a flow entry issuing module.

The gateway configuring module may configure a Layer-three gateway for a network segment in a hybrid network device within the SDN network, and generate a virtual host for the gateway in a SDN controller. IP address and MAC address of a virtual host may be respectively IP address and MAC address of the gateway. The output port of the virtual host may be Normal port.

When the SDN network has a plurality of network segments, then the gateway configuring module may configure a respective Layer-three gateway for each network segment in the hybrid network device. When the SDN network has one network segment, then the gateway configuring module may configure a Layer-three gateway corresponding to the network segment to in the hybrid network device.

The flow entry issuing module may receive a Packet-in message encapsulated with a Layer-three data packet from a SDN network device, calculate the optimum path from source MAC address of the Layer-three data packet to destination MAC address of the Layer-three data packet, based on learned SDN network topology and virtual host generated by the gateway configuring module, and issue a flow entry to each network device in the optimum path. Subsequently, each network device may forward the Layer-three data packet to a device corresponding to the destination MAC address, based on the flow entry issued to each network device.

When the data packet received by the flow entry issuing module meets the following conditions, e.g., source IP address and source MAC address of the data packet may be respectively IP address and MAC address of a first host in a first network segment, destination IP address of the data packet may be IP address of a second host in the first or second network segment, destination MAC address of the data packet may be gateway MAC address of the first network segment, the flow entry issuing module may calculate the optimum path from source MAC address of the data packet to destination MAC address of the data packet, based on learned SDN network topology and generated virtual host.

The foregoing optimum path is from ingress port of the data packet in the SDN network device to Normal port of the virtual host, which may correspond to gateway MAC address of the first network segment.

The process for the flow entry issuing module to issue the flow entry to each network device in the optimum path may include as follows. Based on the data packet and the optimum path, the flow entry issuing module may generate a flow entry to be issued to gateway of the first network segment. Content of the flow entry may be as follows. A data packet which may meet the following conditions. The destination MAC address of the data packet may be gateway MAC address of the first network segment. The action of the data packet may be Output. The output port of the data packet may be Normal port.

After issuing the flow entry to each network device in the optimum path, the flow entry issuing module may encapsulate the data packet into a Packet-out message. The output port carried by the Packet-out message may be to the output port of the SDN network device transmitting the Packet-in message in the optimum path. And the optimum path may be from the SDN network device transmitting the Packet-in message to the gateway of the first network segment. The flow entry issuing module may further transmit the Packet-out message to the SDN network device transmitting the Packet-in message. Subsequently, after receiving the Packet-out message, the SDN network device transmitting the Packet-in message may forward the data packet through the output port.

The Layer-three forwarding device may further include an ARP entry learning module. When receiving the Packet-in message encapsulated with the ARP request packet from the SDN network device, in which the ARP request packet may be transmitted by a host connected with the SDN network device, and destination IP address of the ARP request packet may be gateway IP address, the ARP entry learning module may search out a corresponding virtual host based on the gateway IP address, take MAC address of the virtual host as the gateway MAC address and fill into an ARP reply packet, encapsulate the ARP reply packet into Packet-out message, and transmit the Packet-out message to the host transmitting the ARP request packet through the SDN network device. The ARP entry learning module may configure an ARP entry in a gateway corresponding to the gateway IP address. IP address and MAC address in the ARP entry may be respectively source IP address and source MAC address of the ARP request packet. The output port in the ARP entry may be the output port of the gateway in the optimum path. And the optimum path may be from the gateway to the host transmitting the ARP request packet.

The SDN controller in the present disclosure may be a programmable device, which may combine hardware with machine readable instructions. From the aspect of hardware, schematic diagram illustrating hardware structure of the SDN controller may refer to FIG. 11. FIG. 11 is a schematic diagram illustrating hardware structure of a SDN controller, which may include a Layer-three forwarding device of the SDN network, in accordance with an example of the present disclosure. The SDN controller may include a non-transitory storage, a central processing unit (CPU), a memory and other hardware.

The non-transitory storage may store instruction codes. The CPU may communicate with the non-transitory storage, read the instruction codes stored in the non-transitory storage to the memory to be run, so as to complete functions of the foregoing Layer-three forwarding device in the SDN network as shown in FIG. 11.

The SDN controller may further include a memory and a network interface.

The CPU may further read computer program instructions corresponding to the non-transitory storage to the memory to be run.

The network interface may receive and transmit a data packet between the SDN controller and a hybrid network device in the SDN network, or between SDN network devices.

FIG. 12 is a schematic diagram illustrating structure of a Layer-three forwarding device applied in a hybrid network device of the SDN network, in accordance with an example of the present disclosure. As shown in FIG. 12, the Layer-three forwarding device applied in the hybrid network device of the SDN network may include a gateway configuration storing module, a flow entry receiving module and a data forwarding module.

The gateway configuration storing module may receive a VLAN virtual interface and an IP address of a Layer-three gateway of each network segment in the SDN network, which may be configured by a SDN controller, respectively generate a gateway MAC address for each VLAN virtual interface, provide each gateway MAC address for the SDN controller, and store IP address and MAC address of each gateway.

The flow entry receiving module may receive and store a flow entry issued by the SDN controller. The destination MAC address in the flow entry may be Layer-three gateway MAC address configured for the hybrid network device. The action in the flow entry may be Output. The output port in the flow entry may be Normal port.

The data forwarding module may receive a data packet from a SDN network device. Source IP address and source MAC address of the data packet may be respectively IP address and MAC address of a first host in a first network segment. Destination IP address of the data packet may be IP address of a second host in the first or second network segment. Destination MAC address of o10 the data packet may be gateway MAC address of the first network segment. After matching the flow entry stored by the flow entry receiving module with the data packet, the data forwarding module may learn that the output port in the flow entry may be Normal port, and then perform Layer-two/Layer-three forwarding process to the data packet.

Based on the destination IP address of the data packet, the data forwarding module may search out the corresponding MAC address and the output port in ARP entries of the hybrid network device, replace the destination MAC address of the data packet with the MAC address searched out, search out the gateway MAC address of the second network segment, based on the second network segment located by the destination IP address of the data packet, replace the source MAC address of the data packet with the gateway MAC address, and forward the data packet through the output port searched out.

The hybrid network device provided by the example of the present disclosure may be a programmable device, which may combine hardware with machine readable instructions. From the aspect of hardware, schematic diagram illustrating hardware structure of the hybrid network device may refer to FIG. 13. FIG. 13 is a schematic diagram illustrating hardware structure of a hybrid network device in the SDN network, in accordance with an example of the present disclosure. The hybrid network device may include a non-transitory storage, a CPU, a memory and other hardware.

The non-transitory storage may store instruction codes. When the instruction codes are executed by the CPU, functions of the Layer-three forwarding device of the SDN network in the memory may be implemented.

The CPU may communicate with the non-transitory storage, read and execute the instruction codes stored in the non-transitory storage, and complete functions of foregoing Layer-three forwarding device in the SDN network.

When the instruction codes in the non-transitory storage are executed, functions of the Layer-three forwarding device of the SDN network in the memory may be implemented.

The hybrid network device may further include a network interface.

The network interface may receive and transmit a data packet to between the SDN controller and the hybrid network device.

The Layer-three forwarding device in the SDN network shown in FIG. 10 and FIG. 12 may be implemented through a structure different from that described in the above example. For example, some or all of the above may be implemented by application specific integrated circuits (ASIC) or filed-programmable gate array (FPGA) instead of by machine readable instructions executed by a CPU.

Thus, it can be seen that, in the present disclosure, by configuring a Layer-three gateway in the hybrid network device of the SDN network, inter-network segment communication within the SDN network may be implemented. Layer-three communication between the SDN network and the non-SDN network may also be implemented.

1. A method for forwarding a data packet in a software defined network (SDN) network, comprising:
configuring, by a SDN controller, a Layer-three gateway of a network segment in a hybrid network device within the SDN network, generating a virtual host for the gateway in the SDN controller, wherein an internet protocol (IP) address and a media access control (MAC) address of the virtual host are respectively the IP address and the MAC address of the gateway, an output port of the virtual host is a Normal port;
receiving, by the SDN controller, a Packet-in message encapsulated with a data packet from a SDN network device, calculating an optimum path from a source MAC address of the data packet to a destination MAC address of the data packet, based on a learned SDN network topology and the generated virtual host, issuing a flow entry to each network device in the optimum path, such that each network device forwards the data packet to a device corresponding to the destination MAC address, based on the flow entry issued to the each network device.

2. The method according to claim 1, wherein when a source IP address and a source MAC address of the data packet are respectively the IP address and the MAC address of a first host within a first network segment, a destination IP address of the data packet is the IP address of a second host within the first or second network segment, the destination MAC address of the data packet is a gateway MAC address of the first network segment;
wherein the optimum path from the source MAC address of the data packet to the destination MAC address of the data packet, which is calculated based on the learned SDN network topology and the generated virtual host is:
the optimum path from an ingress port of the data packet in the SDN network device to the Normal port of a virtual host, which may correspond to the gateway MAC address of the first network segment.

3. The method according to claim 2, wherein issuing the flow entry to each network device in the optimum path comprises:
generating a flow entry issued to a gateway of the first network segment, based on the data packet and the optimum path, wherein content of the flow entry comprises:
the destination MAC address of a data packet is the gateway MAC address of the first network segment, an action of the data packet is output, and the output port of the data packet is the Normal port.

4. The method according to claim 3, further comprising:
after issuing the flow entry to each network device in the optimum path, encapsulating, by the SDN controller, the data packet into a Packet-out message, wherein the output port carried by the Packet-out message is the output port of the SDN network device transmitting the Packet-in message in the optimum path, which is from the SDN network device transmitting the Packet-in message to the gateway of the first network segment, transmitting the Packet-out message to the SDN network device transmitting the Packet-in message, such that the SDN network device transmitting the Packet-in message transmits the data packet through the output port, after receiving the Packet-out message.

5. The method according to claim 1, further comprising:
after receiving the Packet-in message encapsulated with an address resolution protocol (ARP) request packet from the SDN network device, wherein the ARP request packet is transmitted by a host connecting with the SDN network device, and the destination IP address of the ARP request packet is the gateway IP address, searching out, by the SDN controller, a corresponding virtual host based on the gateway IP address, taking the MAC address of the virtual host as the gateway MAC address and filling into an ARP reply packet, encapsulating the ARP reply packet into a Packet-out message, and forwarding the Packet-out message to the host transmitting the ARP request packet through the SDN network device,
configuring, by the SDN controller, an ARP entry in a gateway corresponding to the gateway IP address, wherein the IP address and the MAC address in the ARP entry are respectively the source IP address and the source MAC address of the ARP request packet, the output port in the ARP entry is the output port of the gateway in the optimum path, which is from the gateway to the host transmitting the ARP request packet.

6. A Layer-three forwarding device in a software defined network (SDN) network, which is located in a SDN controller, wherein the Layer-three forwarding device comprises a gateway configuring module and a flow entry issuing module;
the gateway configuring module is to configure a Layer-three gateway for a network segment in a hybrid network device within the SDN network, generate a virtual host for the gateway in the SDN controller, wherein an internet protocol (IP) address and a media access control (MAC) address of the virtual host are respectively the IP address and the MAC address of the gateway, an output port of the virtual host is a Normal port; and,
the flow entry issuing module is to receive a Packet-in message encapsulated with a Layer-three data packet from a SDN network device, is calculate an optimum path from a source MAC address of the Layer-three data packet to a destination MAC address of the Layer-three data packet, based on a learned SDN network topology and the generated virtual host, issue a flow entry to each network device in the optimum path.

7. The device according to claim 6, wherein when a source IP address and the source MAC address of the data packet received by the flow entry issuing module are respectively the IP address and the MAC address of a first host in a first network segment, a destination IP address of the data packet is the IP address of a second host in the first or second network segment, the destination MAC address of the data packet is a gateway MAC address in the first network segment;
wherein the optimum path from the source MAC address of the data packet to the destination MAC address of the data packet, which is calculated based on the learned SDN network topology and generated virtual host is:
the optimum path from an ingress port of the data packet in the SDN network device to the Normal port of a virtual host, which corresponds to the gateway MAC address of the first network segment.

8. The device according to claim 7, wherein the flow entry issuing module is further to:
generate the flow entry issued to a gateway of the first network segment, based on the data packet and the optimum path, wherein content of the flow entry comprises:
the destination MAC address of the data packet being the gateway MAC address of the first network segment, an action of the data packet being output, and the output port of the data packet being the Normal port.

9. The device according to claim 7, wherein the flow entry issuing module is further to encapsulate the data packet into a Packet-out message, wherein the output port carried by the Packet-out message is the output port of the SDN network device transmitting the Packet-in message in the optimum path, and the optimum path is from the SDN network device transmitting the Packet-in message to the gateway of the first network segment, the flow entry issuing module is further to transmit the Packet-out message to the SDN network device transmitting the Packet-in message, such that the SDN network device transmitting the Packet-in message transmits the data packet through the output port, after receiving the Packet-out message.

10. The device according to claim 6, wherein the device further comprises an ARP entry learning module, when receiving the Packet-in message encapsulated with an address resolution protocol (ARP) request packet from the SDN network device, wherein the ARP request packet is transmitted by a host connected with the SDN network device, and the destination IP address of the ARP request packet is the gateway IP address, the ARP entry learning module is to search out a corresponding virtual host based on the gateway IP address, take the MAC address of the virtual host as the gateway MAC address and fill into an ARP reply packet, encapsulate the ARP reply packet into a Packet-out message, forward the Packet-out message to the host transmitting the ARP request packet through the SDN network device, the ARP entry learning module is further to configure an ARP entry in a gateway corresponding to the gateway IP address, wherein the IP address and the MAC address in the ARP entry are respectively the source IP address and the source MAC address of the ARP request packet, the output port in the ARP entry is the output port of the gateway in the optimum path, and the optimum path is from the gateway to the host transmitting the ARP request packet.

11. A Layer-three forwarding device in a software defined network (SDN) network, which is located in a hybrid network device in the SDN network, comprising a gateway configuration storing module, a flow entry receiving module and a data forwarding module, wherein
to the gateway configuration storing module is to receive a virtual local area network (VLAN) virtual interface and an internet protocol (IP) address of a Layer-three gateway of a network segment in the SDN network, which are configured by a SDN controller, respectively generate a gateway media access control (MAC) address for a VLAN virtual interface, provide the gateway MAC is address for the SDN controller, store the IP address and the MAC address of the gateway;
the flow entry receiving module is to receive and store a flow entry issued by the SDN controller, wherein a destination MAC address in the flow entry is a Layer-three gateway MAC address configured by the hybrid network device, action in the flow entry is Output, and an output port in the flow entry is a Normal port; and,
the data forwarding module is to receive a data packet from a SDN network device, wherein a source IP address and a source MAC address of the data packet are respectively the IP address and the MAC address of a first host in a first network segment, a destination IP address of the data packet is the IP address of a second host within the first or second network segment, the destination MAC address of the data packet is the Layer-three gateway MAC address of the first network segment, match the data packet with the flow entry, learn that the output port in the flow entry is a Normal port, and perform a Layer-two/Layer-three forwarding process to the data packet.

12. The device according to claim 11, wherein the data forwarding module is further to:
search for the corresponding MAC address and the output port in ARP entries of the hybrid network device, based on the destination IP address of the data packet, replace the destination MAC address of the data packet with the MAC address searched out, search out the gateway MAC address of the second network segment in the hybrid network device, based on the second network segment located by the destination IP address of the data packet, replace the source MAC address of the data packet with the gateway MAC address, and forward the data packet through the output port searched out.
